(19) United States
(12) Patent Application Publication
(10) Pub. No.: US 2022/0122570 A1
(43) Pub. Date: Apr. 21, 2022

(54) INTERACTIVE PERFORMANCE SYSTEM AND METHOD

(71) Applicant: Carolyn Ke'von Malachi, Baltimore, MD (US)

(72) Inventor: Carolyn Ke'von Malachi, Baltimore, MD (US)

(21) Appl. No.: 17/451,243

(22) Filed: Oct. 18, 2021

Related U.S. Application Data
(60) Provisional application No. 63/198,423, filed on Oct. 16, 2020.

(51) Int. Cl. G10H 1/00

(52) U.S. Cl. CPC G10H 1/0058; G10H 1/0025; G10H 1/0083; G10H 2240/181; G10H 2210/091; G10H 2240/305; G10H 2240/311; G10H 2240/175

(57) ABSTRACT

A method of processing textual and graphical feedback of a virtual audience of a performance for compensating and providing sonic cues to the performers through monetizing and audially representing, respectively, the textual and graphical feedback.

### CROSS-REFERENCE TO RELATED APPLICATION

This application claims the benefit of priority of U.S. provisional application No. 63/198,423, filed 16 Oct. 2020, the contents of which are herein incorporated by reference.

### BACKGROUND OF THE INVENTION

The present invention relates to computer and software applications and systems in the separate areas of blockchain and sonification, and more particularly to an unprecedented interactive performance system and method, and a system for converting interactive data into money and sound.

As a result of the COVID-19 pandemic, live music venues remain closed, and royalty payments to professional musicians remain slow. Professional musicians, people who earn a living wage by performing music in public spaces, face two problems: income reduction compounded by a complex, inefficient royalty payment system; and virtual concerts which mute audiences and rob artists of critical sonic cues. Artists in the virtual space cannot hear audiences as they would in the physical performance space. Also, in the virtual space, artists are not paid as well or as often as they would be if they could perform regularly in physical and live music venues.

Existing methods of analyzing audience data result in the simple delivery of long-term audience demographics (location, age and gender) to the artist. Real-time audience data is unavailable.

Systems in the fields blockchain and sonification, operate separately and are not used in tandem to answer the aforementioned monetary and audible feedback problems faced by performing artists.

As can be seen, there is a need for a solution to one or more of the foregoing problems.

### SUMMARY OF THE INVENTION

In one aspect of the present invention, a system including the following: at least one computing device; at least one user input device in communication with the at least one computing device; an acoustic stimulation program in communication with the at least one computing device; the at least one computing device configured to: receive, over a communication network from at least one remote computing device with at least one remote user, a textual and graphical feedback from each of the at least one remote user responsive to an audio output via the at least one user input device, the textual and graphical feedback filtered for one or more positive responses using a keyword and emoji lookup table; assign digital currency value to each positive response; and modify presentation of each positive response at the at least one computing device based at least partly on the received textual and graphical feedback from each of the at least one remote user and at least one presentation modification rule associated with the acoustic stimulation program, wherein the presentation modification rule is configured to provide a sonic cue associated with the audio output, wherein a predetermined time increment is associated with each assignment of digital currency and each modified presentation.

In another aspect of the present invention, the system further includes a blockchain smart contract n communication with the at least one computing device, wherein each assignment of digital currency is based at least partly on the blockchain smart contract.

In yet another aspect of the present invention, the system includes the following: at least one computing device; at least one remote output device in communication with the at least one computing device; an extraction engine in communication with the at least one computing device; the extraction engine configured to: receive, over a communication network from the at least one remote output device with at least one remote user, a textual feedback and/or a graphical feedback responsive to a performance output via the at least one computing device, the textual feedback and graphical feedback analyzed for one or more positive responses using a text and graphic database; and modify presentation of each positive response at the at least one computing device based at least partly on the received textual and graphical feedback from each of the at least one remote user and at least one presentation modification rule associated with one or more spatial harmonic coefficient, wherein the presentation modification rule is configured to generate a plurality of a three-dimensional sonic cues associated with the performance output.

In further embodiments, the system may also include the following: a blockchain smart contract operatively associated with the extraction engine, wherein the extraction engine is configured to assign digital currency value to the performance output, wherein a predetermined time increment is associated with each assignment of digital currency and each modified presentation, wherein each positive response a responsive parameter of the textual and graphical feedback; and including an interactive module in communication with the at least one computing device, wherein the interactive module defines a digital signal based partly on the responsive parameter; and including an acoustic simulation program in communication with the at least one computing device, wherein the acoustic simulation program applies the at least one presentation modification rule against the digital signal to generate the plurality of a three-dimensional sonic cues, wherein the acoustic simulation program applies the at least one presentation modification rule based on a performer-selected spatial harmonic coefficients, wherein the performer-selected spatial harmonic coefficients are associated with a pre-existing venue.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention.

FIG. 2 is a diagrammatic view of an exemplary embodiment of the present invention, shown in use.

FIG. 3 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an interactive performance system and method. The present invention is directed to computer and software application and systems in the unrelated areas of blockchain and sonification, and provides an unprecedented interactive performance system and method, and a system for converting interactive data into money and sound.

The system of the present invention may include at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

The system and method of the present invention combine blockchain and sonification to analyze incoming data from virtual audiences base on a set of rules to generate automate commensurate payment to the artist(s) and render sonification of that incoming data so that the artist(s) may hear the audience as they perform. In other words, the system and method of the present invention uses virtual audience data to deliver real-time compensation and sonic cues to artists performing in the digital space.

The system and method of the present invention distinguish over and differ from current approaches of analyzing audience data, which simply deliver long-term audience demographics (location, age and gender) to the artist. The system and method of the present invention may use real-time audience interactive data (feedback) to allow the artist to hear the audience and be commensurately compensated, while maintaining the privacy of the artist's audience and allowing.

Existing systems, in contrast, that use blockchain to exchange funds on social media platforms require individual users to share private information with other users. Further, sonification systems simply provide sounds that guide the user through their platform experience. However, the system and method of the present invention combines blockchain and sonification to analyze incoming virtual audience textual and graphical feedback based on at least one set of rules to represent said textual and graphical feedback as audio feedback and the basis of payment to the artist.

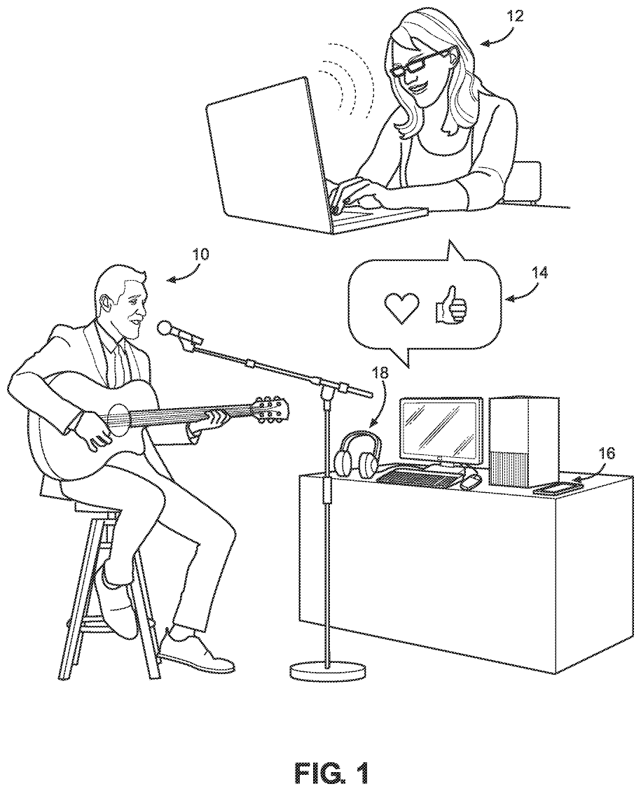

Referring to FIG. 1, the present invention may provide a system and method for interactive performance. FIG. 1 shows the interactive performance system in use, in accordance with an exemplary embodiment of the present invention. The system includes one or more of the following components and combinations thereof: a performer 10; an audience 12; the communication between the audience and performer 14; a cell phone 16; and headphones 18.

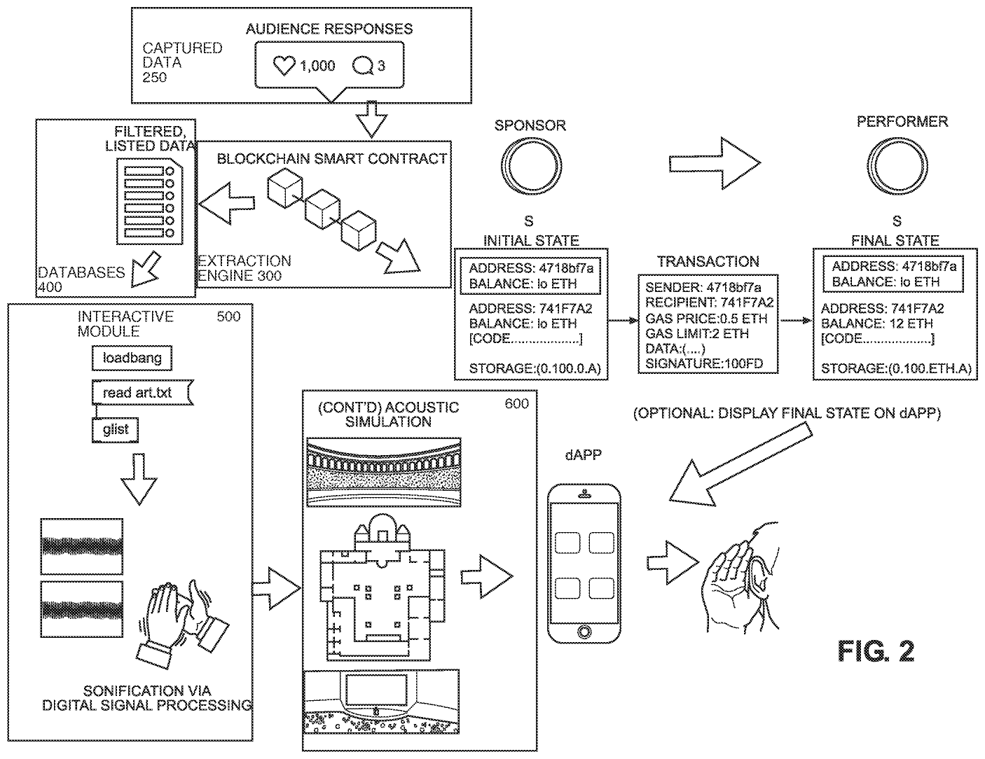

FIG. 2: is a schematic diagram of an embodiment of the overall interactive performance system embodied in the present invention.

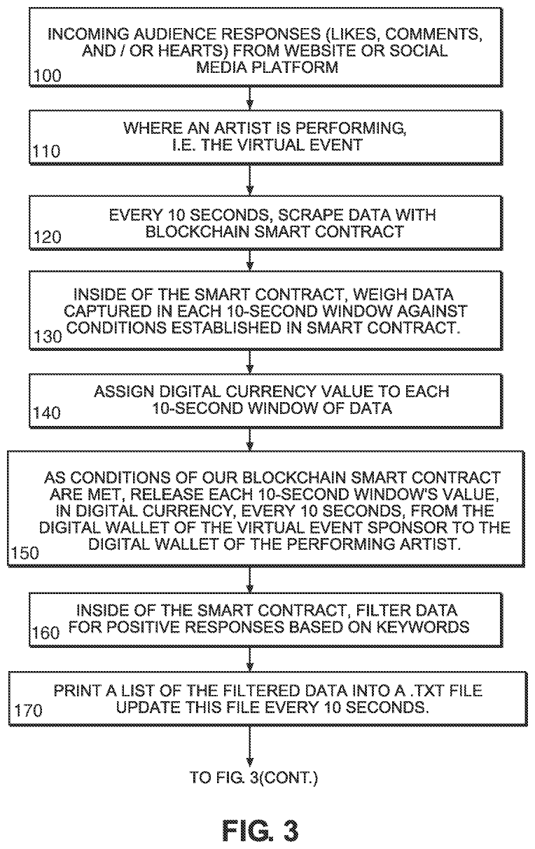

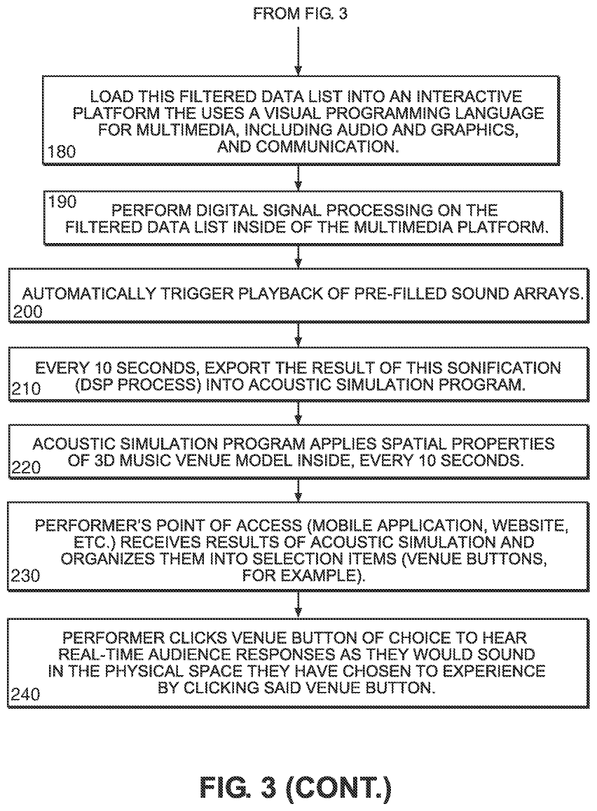

Referring to FIG. 3 the present invention may comprise one or more of the following systemic components and/or combinations thereof.

Component 100: Incoming captured data 250, in certain embodiments audience responses or output of remote user from their remote computing devices (or user interfaces thereof) including textual, audio, and graphical (likes, comments, and/or hearts) via one or more remote user interfaces, which include but are not limited to website or social media platforms.

Component 110: Wherein an artist is performing to one or more remote consumers/users, i.e., the virtual event.

Component 120: At predetermined time increments, the system scrapes/extracts data via extraction engine 300 operatively associated with a blockchain smart contract.

Component 130: Inside of the blockchain smart contract, weigh data captured in each time increment window against conditions established in the blockchain smart contract.

Component 140: Assign digital currency value to each time-increment window of data.

Component 150: As conditions of our blockchain smart contract are met, the system may release digital currency, at each time-increment window's value at the same or other predefined time-increment, from the digital wallet of the virtual event sponsor to the digital wallet of the performing artist/performer.

Component 160: Inside of the blockchain smart contract/extraction engine 300, captured data 250 from the remote user output associated with the virtual event is detected, extracted, analyzed, and/or filtered for different response types based on keywords, key textual outputs, key graphical output, including pictograms, key audio output, key video output and/or the like. The different response types may include but are not limited to positive responses, neutral responses, and negative responses. The response types and the keywords, key textual outputs, key graphical output, including pictograms, key audio output, key video output may be defined in the blockchain smart contract/extraction engine 300. The resulting determination of the response types defines one or more responsive parameter of the captured remote user data.

Component 170: The storage of the responsive parameters may include, but is not limited to, exporting to one or more databases 400 or printing a list of the filtered data/ responsive parameters into a .txt file, which may be updated based on the time increment.

Component 180: The responsive parameters may be exported to an interactive module 500 of the system embodied in the present invention, wherein the interactive module 500 employs a visual programming language or other software for processing multimedia (e.g., audio, video, textural, and graphical) communication.

Component 190: The interactive platform performs digital signal processing on the filtered data list/responsive parameters inside of the interactive module 500. In certain embodiments, the interactive module 500 may generate a bitstream based partly on the responsive parameters, wherein the bitstream enables digital signal processing and resulting generation of three-dimensional sound fields that the performer of the virtual event receives and can selectively process as sonic cues associated with said virtual event.

Component 200: In certain embodiments, the interactive module 500 automatically triggers playback of pre-filled sound arrays or three-dimensional representation of a sound field (discussed more below).

Component 210: At the predetermined incremental time the present invention may export the result of this sonification of the remote user output into an acoustic simulation module 600.

Component 220: Acoustic simulation module 600 applies spatial properties of three-dimensional (3D) music venue model inside, every time increment, based on the specific venue or invented venue's spatial property signature (more below).

Component 230: Performer's point of access (mobile application, website, or the like) may receive results of acoustic simulation module 600 and may organize them into selection items (venue buttons, for example).

Component 240: Performer may click venue button of choice to hear real-time audience responses as they would sound in the physical space, they have chosen to experience by clicking said venue button.

In an exemplary embodiment, the elements or components of the present invention may interrelate in the following manner. Components 100 and 110 apply to anyone—person, animal, robot, entity—performing, speaking, teaching, playing organized sports, sleeping, participating in any activity which they choose to stream or display in any virtual environment, these individual(s)/entities are referred to herein as the performer(s). Components 120 captures remote user output/data 250 associated with the virtual event and extracts vital audience response data: how many times people watching the event responded with hearts, likes, comments, shares, emoji and other means of interacting with the performer on the platform. This means of data extraction may be built into a blockchain smart contract which automates Components 140 through 180. The value stored in the virtual event sponsor's wallet (Component 150) represents the performer's earning potential and the limits of the sponsor's financial obligation. The performer may receive payment when Component 150 completes. In Component 160, as mentioned above, “positives” refers to capture data 250 from the remote users that matches identifiers including in the blockchain smart contract/extraction engine 300. Component 180 may automatically load the result of Component 130 and Component 170, and by doing so triggers the sonification process described in Components 190 through 210. Component 220 may automatically receive the result of earlier Components, then completes its process before sending the final result to the points of access mentioned in Component 230. The venue button can be named anything and refers to any part of the software application, website, or the like, which allows the performer to choose how they want to experience (hear) sonified audience data. The performer may access sonification results in Component 240 using any listening method: in-ear monitors, bone conduction headphones or a different sound reinforcement tool.

By following the above steps, in the order listed, a blockchain smart contract may convert real-time virtual audience data into meaningful income and sonic feedback.

If no audience members participate, the conditions of the smart contract will not be met. If the conditions of the smart contract are not met, then the performer will receive neither the payment nor sonic feedback. Without data to meet established conditions, the system is unable to run. The system operation may depend on the active participation of the audience which may be assessed through typical likes, hearts, comments, or the like.

The system may be made by a process including the above-listed steps. Virtual performance platforms, blockchain technology, sonification tools, multimedia programming environments, acoustic simulation and point of access are necessary components. From the virtual performance platform, the blockchain smart contract may obtain the audience response data, which may be used to release payment and trigger the sonification that happens in the multimedia programming environment and in the acoustic simulation which the performer experiences by making selections at the point of access. The specific blockchain and conditions of the smart contract are flexible.

The above-mentioned extraction engine 300 can receive the capture data 250 embodied in the remote user output to determine, extract, analyze and filter response parameters of such captured data for subsequent processing. To do so, the extraction engine 300 can be configured by being operatively associated with the blockchain smart contract, whereby mutable terms thereof are used in the functionality of the extraction engine 300.

In some embodiments, an additional element capable of automating keywords, textual elements, graphical elements, and the like relevant to audience demographics or automatically translating to the native language of the commenters (virtual audience members) would make the system and method work better, as people from different cultures use different words and graphics and symbols to express their feelings, which the present disclosure extracts to accurately convey audience sentiment to the performer using real-time sonified data. Another possibility is integrating an embodiment of the invention into the virtual event platform itself which would eliminate the need for the performer to have a separate point of access.

In an exemplary embodiment of the present invention, the smart contract may be used to send payment to multiple recipients. Performers may then use the system to share income with other parties including, but not limited to other managers, agents, other musicians, and non-profit organizations. Incoming audience response data, paired with footage from the virtual event, may be used to give the performers an audio-visual record of how the audience responded to their performances. In an exemplary embodiment the present invention may use blockchain smart contracts to interpret data and trigger two processes; it may remain flexible in its development in anticipation of future technologies that will make its internal workings operate with greater efficiency. The point of access may also be used to display digital wallet deposit confirmations happening as a result of the automated smart contract transactions.

In an exemplary embodiment the present disclosure may be used in the following manner. A performer may be the end user of this process. A performer may interface with the system at a point of access (described above) that updates as the invention's background operations are automated and triggered by incoming responses from the performer's virtual audiences.

As the present invention may use audience interaction, not demographic or other details, to function, the system and method of the present invention may be used as a way for corporate advertisers on broadcast media platforms to automate payments to networks based on real-time audience interaction, giving the sponsor and network transparent information about audience behavior while respecting the audience's right to privacy. This system and method of the present invention may be used for any data-based branding or marketing effort, campaign or initiative wherein the digital media platform (social or otherwise) is the data intermediary. In the age of privacy concerns, this type of invention may have widespread use.

In an exemplary embodiment the present invention may be employed as a music production tool. The system and method may use blockchain smart contracts which may execute terms of agreement based on conditions written into the smart contract code. As incoming audience response data triggers contract execution, it is possible to use an embodiment of the present invention to create compositions (lyrics, music and arrangement) constructed from the responses of virtual audience members which indicate the audience's preferences. The performer may conceivably use this information to compose for the audience and release that composition commercially. It may also be possible for the performer to record the sonic output of the invention and use that as a basis for composition which could also be commercially released. Lastly, it may be possible to aggregate the broad spectrum of output from the invention and reinterpret that to produce compositions which may reflect the sonic experience of the performer in the virtual space, hearing the sonified physical space, while playing the sonified back into the virtual space. The system and method of the present invention may also be used in the college or professional sports environment where crowds attend games, competitions, matches, and other events virtually.

In summary, in an exemplary embodiment, the present invention may provide an interactive performance system; and a system and method for converting interactive data into money and sound. The system and method of the present invention may combine blockchain and sonification to analyze incoming data from virtual audiences, automate payment to the artist, and sonify that data so the artist can hear the audience as they perform.

In one aspect, a method comprises decoding a bitstream to generate a three-dimensional representation of a sound field. The bitstream may be a product of the captured data 250 of the audience response/remote user output. Specifically, the bitstream defines response parameters which enable generation of digital process signal extracted from the audience response/captured data 250. The response parameters may be analyzed and stored as a value reflecting a qualified positive response, neutral response, and/or negative response of the remote audience. Said value may be the average value over a specified time increment as compared to previous time increments or said value may be a real-time discrete indication of one of the plurality of response types, or said value may be continuous representation of continuous indications of response types as a function of time. The present invention contemplates using a timer and appropriate computer processing functionality known in the computer arts.

In certain embodiments, the appropriate computer processing functionality known in the computer arts may render this bitstream or signal of audience responses into multi-channel audio data to apply thereto spatial harmonic coefficients or other audio elements/spatial properties to produce the three-dimensional representation of a sound field.

In certain embodiments, one or more of the spatial harmonic coefficients or other spatial audio properties may defined in the blockchain contract/generation engine as default values or as user-defined values. In some embodiments, via the acoustic simulation program, the spatial harmonic coefficients or other audio elements/spatial properties may be selected from a list of predefined venue-specific sets. As in specific venues may have signature spatial harmonic coefficients or other audio elements/spatial properties, say, Carnegie Hall™ or other well-known venues, have a known venue-specific set of spatial harmonic coefficients or other audio elements/spatial properties which will be applied to the multi-channel audio data.

In certain embodiments, the interactive platform may include or be part of a network, which may be any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The interactive platform may obtain textual and graphical communication from a text message, an email message, an instant message, a webpage, and/or the like. The computing interactive platform may parse the words and pictograms contained within the textual and graphical communication to determine one or more positive response embodied in the textual and graphical communication. Computing system and/or server of the interactive platform may perform machine translation on the text and graphics.

In accordance with another aspect of the present invention, the at least one computing device may be configured to receive textual and graphical communication content during a performance session established over a communications network with at least one remote computing device.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A system comprising:
at least one computing device;
at least one remote output device in communication with the at least one computing device;
an extraction engine in communication with the at least one computing device;
the extraction engine configured to:
receive, over a communication network from the at least one remote output device with at least one remote user, a textual feedback and/or a graphical feedback responsive to a performance output via the at least one computing device, the textual feedback and graphical feedback analyzed for one or more positive responses using a text and graphic database; and
modify presentation of each positive response at the at least one computing device based at least partly on the received textual and graphical feedback from each of the at least one remote user and at least one presentation modification rule associated with one or more spatial harmonic coefficient, wherein the presentation modification rule is configured to generate a plurality of a three-dimensional sonic cues associated with the performance output.

2. The system of claim 1, further comprising a blockchain smart contract operatively associated with the extraction engine, wherein the extraction engine is configured to assign digital currency value to the performance output.

3. The system of claim 2, wherein a predetermined time increment is associated with each assignment of digital currency and each modified presentation.

4. The system of claim 1, wherein each positive response a responsive parameter of the textual and graphical feedback.

5. The system of claim 4, further comprising an interactive module in communication with the at least one computing device, wherein the interactive module defines a digital signal based partly on the responsive parameter.

6. The system of claim 5, further comprising an acoustic simulation program in communication with the at least one computing device, wherein the acoustic simulation program applies the at least one presentation modification rule against the digital signal to generate the plurality of a three-dimensional sonic cues.

7. The system of claim 6, wherein the acoustic simulation program applies the at least one presentation modification rule based on a performer-selected spatial harmonic coefficients.

8. The system of claim 7, wherein the performer-selected spatial harmonic coefficients are associated with a pre-existing venue.
